(19) United States
(12) Patent Application Publication
(10) Pub. No.: US 2005/0024866 A1
(43) Pub. Date: Feb. 3, 2005

(54) Device for radiating light

(76) Inventor: Petrus Josephus Homan, Waverveen (NL)

Correspondence Address: KRAMER & AMADO, P.C., 2001 JEFFERSON DAVIS HWY, SUITE 1101, ARLINGTON, VA, 22202, US

(21) Appl. No.: 10/620,371

(22) Filed: Jul. 17, 2003

(51) Int. Cl. F21S 4/00

(52) U.S. Cl. 362/219

(57) ABSTRACT

The present invention relates to a device for radiating light, comprising: a substantially tube-like casing, comprising: a relatively large number of light sources arranged in the interior of the casing, conducting means for connecting the light sources in electrically conducting manner, wherein the conducting means are arranged in the interior of the casing.

The present invention relates to a device for radiating light in the form of long strings with light sources which realize an attractive, decorative effect. Devices with such a decorative effect are already known. However, due to the plurality of light sources, such devices use a great deal of energy.

In order to obviate this drawback, the present invention provides a device for radiating light, comprising:
a frame with a predetermined decorative shape,
a substantially tube-like casing, comprising:
a relatively large number of light sources arranged in the interior of the casing,
conducting means for connecting the light sources in electrically conducting manner,
   wherein the conducting means are arranged in the interior of the casing, wherein
the casing is arranged on the frame in accordance with a predetermined shape.

The light sources are preferably LEDs. The energy consumption is hereby reduced. As a light source LEDs further have a very great robustness and a long lifespan of up to for instance 20 years. The devices hereby acquire a high reliability during use. A further advantage of the use of LEDs is that these are safer in use, for instance because the heat development is much lower. The use of LEDs in such devices further becomes attractive in that different colours of LED have recently become available.

In addition, the light sources are preferably connected in groups. A voltage source having a higher voltage than required per light source can for instance hereby be applied.

In a further preferred embodiment the light sources are positioned in the casing at a mutual distance of for instance 1-15 centimetres. Placing of light sources at such distances produces an effect of continuity to a series of light sources in such a casing.

An above described device can have a length of up to for instance 250 metres. The making of large decorations illuminated using the device hereby becomes very simple, since very few connecting points are necessary.

In a further preferred embodiment the device further comprises switching means for switching separate light sources or groups of light sources. Separate light sources or groups of light sources can hereby be switched on or off, whereby motion-simulating effects can for instance be achieved by means of the light sources placed in the device.

In the field of street decoration with which public spaces are decorated for instance during (and/or prior to) holiday periods, decorations are known in which traditional light bulbs are applied. Such decorations have the drawback that the lighting thereof is very static, since the placing of the light bulbs is determined for instance by the fixed position of the fittings therefor.

In order to obviate such drawbacks, a further aspect of the present invention provides decorations for decorative lighting of (public) spaces, comprising:
a frame with a predetermined decorative shape,
fixing means for fixing the frame to at least a ground or facade of the (public) space,
at least one device according to one or more of claims 1-9 for radiating light, wherein this device is arranged along the frame, wherein the decorative shape of the frame is emphasized in that the lights are arranged therealong.

Such a decoration has the advantage that ornamental lighting can be arranged on the decorations in very simple and/or flexible, changeable manner. In such an application this ornamental lighting has the same advantages as described in the foregoing.

In order to provide a large measure of durability, the frame comprises a metal construction. Such decorations can be used more than once owing to their solid nature.

Further advantages, features and details of the present invention are further explained hereinbelow with reference to the figures, in which:

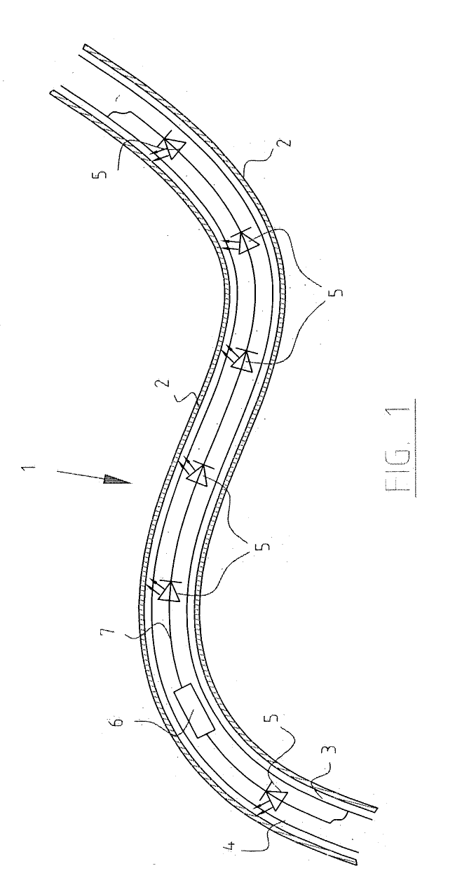

FIG. 1 shows a cross-section of an embodiment according to the present invention,

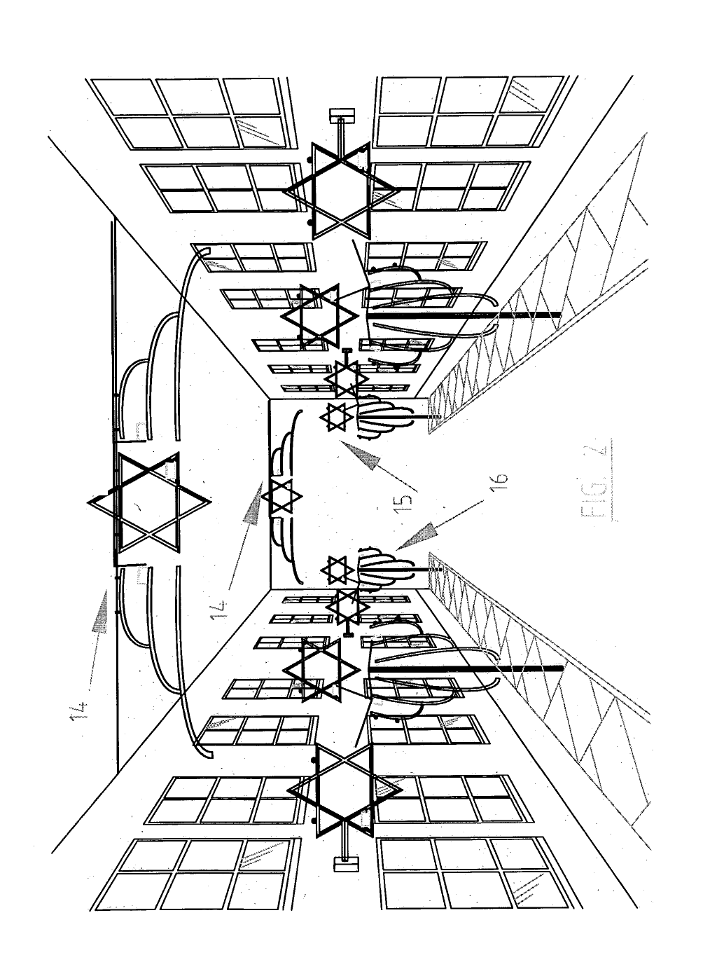

FIG. 2 is a perspective view of three further embodiments according to the present invention.

An embodiment according to the present invention (FIG. 1) shows a part of a substantially tube-like decorative device 1. The decorative device comprises a casing 2 which is substantially tube-like. Two conducting wires 3,4 are arranged herein for supplying electricity. Between these electrical wires are arranged wires 7 which switch one or more LEDs (in the present case 6). Further connected herein are switching means 6 which can comprise electrical components, including for instance resistors or a processing unit.

An object of such switching means 6 is that flashing or motion effects can be realized using the number of light sources positioned in the casing. The operation of such switching means can be controlled from a central control member (not shown) which forms part of the device and which can for instance be arranged at the position of the coupling of the tube to an external power source. A suitable pulse coding can then be applied to control the switching means, these pulses being supplied via wiring 3,4,7.

A switching group of 6 LEDs is described and shown in the foregoing. Further assemblies of connections are for instance 12 LEDs per switching group, 18 LEDs per switching group or 36 LEDs per switching group, although any practical number can be applied depending on for instance manufacture or applied voltage. Such tubes can for instance be produced in a length of about 30 m, 60 m, 90 m or 180 metres respectively.

In groups of 18 an LED for applying can for instance use 0.02 A at 120V, whereby this group has a power of 2.4 Watts. In this case a tube with 360 LEDs and 20 groups uses only 48 Watts of energy.

According to a further aspect of the invention, the above described tube-like decoration or LED tube is applied in ornaments wherein use is traditionally made of light bulbs. Such ornaments are for instance used for lighting public spaces. Ornaments are also used to decorate homes, wherein relatively smaller light bulbs are then applied.

FIG. 2 shows three examples of (outdoor) ornaments on which can be arranged the tube-like light decoration as described above. These examples are not however limitative for the application of the tube-like decoration. Such decorations can take a very solid form for multiple use year after year and in simple manner can obtain a different surprising or attractive appearance using the tube-like decoration.

FIG. 2 shows three embodiments 14, 15 and 16 according to the present invention. Embodiment 14 shows a street-spanning decoration for fixing to a steel cable. Such decorations are often applied above for instance shopping streets during festive periods. Another embodiment 15 relates to a lighting decoration which is especially suitable for fixing to vertical walls. In addition to use in shopping streets, such decorations can also be applied anywhere where vertical walls are available. The same is true for embodiment 16, which is particularly suitable for fixing to a post. Such self-supporting constructions can be placed anywhere where posts can be placed.

The street-spanning decoration 14 can be fixed in the usual manner between two facades, suspended on for instance a steel cable using suspension eyes.

The decorations according to embodiments 14, 15 and 16 are very solid decorations with frames which can be used year after year as street decoration or decoration of for instance large shopping centres. Such frames have already been applied for a long time by applicant, wherein the frames are provided with large quantities of light bulbs. The energy consumption of these decorations is hereby very high. The use of tubes with LEDs can greatly reduce this energy use, while lighting effects can be achieved which have an attention value differing from those achieved with the known light bulbs.

1. Device for radiating light, comprising:
a frame with a predetermined decorative shape,
a substantially tube-like casing, comprising:
a relatively large number of light sources arranged in the interior of the casing,
conducting means for connecting the light sources in electrically conducting manner,
wherein the conducting means are arranged in the interior of the casing, wherein
the casing is arranged on the frame in accordance with a predetermined shape.

2. Device as claimed in claim 1, wherein the light sources are LEDs.

3. Device as claimed in claim 1 or 2, wherein the light sources are connected in groups.

4. Device as claimed in one or more of the foregoing claims, wherein the light sources are positioned in the casing at a mutual distance of 1-15 centimetres.

5. Device as claimed in one or more of the foregoing claims, wherein the light sources are ordered in groups of 4-40 light sources.

6. Device as claimed in one or more of the foregoing claims, wherein the casing has a length of 1-250 metres.

7. Device as claimed in one or more of the foregoing claims, comprising light sources radiating different colours of light.

8. Device as claimed in one or more of the foregoing claims, further comprising switching means for switching separate light sources.

9. Device as claimed in one or more of the foregoing claims, further comprising switching means for switching groups of light sources.

10. Device as claimed in one or more of the foregoing claims, wherein the tube-like casing is at least partially light-transmitting.

11. Decoration for decorative lighting of (public) spaces, comprising:
a device as claimed in one or more of the claims 1-10,
fixing means for fixing the frame to at least a ground or facade of the (public) space,
wherein:
the decorative shape of the frame is emphasized in that the casing is arranged thereon.

12. Decoration as claimed in claim 11, wherein the frame comprises a metal construction.

13. Decoration as claimed in claim 11 or 12, wherein the frame is a spanning construction for fixing between two facades.

14. Decoration as claimed in one or more of the claims 11-13, wherein the frame is provided with fixing means for suspension from a cable stretched between two facades.

15. Decoration as claimed in one or more of the claims 11-13, wherein the frame comprises a vertical part for fixing to or placing on a substantially horizontal ground.

16. Decoration as claimed in one or more of the claims 11-13, wherein the frame comprises a substantially horizontal part for fixing to an facade.

17. Decoration as claimed in claim 16, wherein the horizontal part comprises wall fastening means.
